(19) United States
(12) Patent Application Publication
(10) Pub. No.: US 2026/0119949 A1
(43) Pub. Date: Apr. 30, 2026

(54) Hybrid Quantum Neural Network

(71) Applicant: IONQ, INC., College Park, MD (US)

(72) Inventor: Sayonee RAY, Waterloo (CA)

(21) Appl. No.: 18/926,838

(22) Filed: Oct. 25, 2024

Related U.S. Application Data
(60) Provisional application No. 63/609,685, filed on Dec. 13, 2023.

(51) Int. Cl. G06N 10/60

(52) U.S. Cl. CPC G06N 10/60

(57) ABSTRACT

A method of performing computation in a hybrid quantum-classical computing system includes executing one or more iterations, each iteration including receiving input features of a training sample in a first classical neural network, computing first outputs based on first trainable parameters, setting a quantum processor in an initial state, applying a parametrized quantum circuit to the quantum processor based on the first outputs and a set of variational parameters, the parametrized quantum circuit including encoding layer circuits based on the first outputs, and trainable layer circuits based on the set of variational parameters, and measuring qubit states of the quantum processor, receiving measured expectation values of the qubit states in a second classical neural network, computing second outputs based second trainable parameters, adjusting the first trainable parameters, the plurality of second trainable parameters, and the set of variational parameters.

### CROSS-REFERENCE TO RELATED APPLICATIONS

This application claims priority to U.S. Provisional Application Ser. No. 63/609,685 filed Dec. 13, 2023, which is herein incorporated by reference in its entirety.

### BACKGROUND

### Field

The present disclosure generally relates to a method of performing computations using a hybrid quantum-classical computing system, and more specifically, to a method of solving machine learning (ML) modeling problems in chemical engineering processes in a hybrid computing system that includes a classical computer and a quantum computer that includes trapped ions.

### Description of the Related Art

Chemical engineering is a multidisciplinary branch of engineering that plays a crucial role in providing valuable products to a myriad of industries. The success of chemical engineering lies in its ability to integrate principles from chemistry, physics, and mathematics, using sophisticated techniques. Although many chemical processes have been applied commercially, designing, optimizing, and scaling up these processes are challenging due to the highly complex chemical reactions involved. To address this problem, various commercial software that can calculate the chemical reactions mathematically based on certain theories has been developed. However, these software programs sometimes suffer from long computing times as they consider a large number of reactions and equations. Moreover, despite their successful application in the chemical industry, errors in the computations can still arise due to specific theoretical assumptions.

Machine learning (ML) has emerged as a powerful solution that has revolutionized various industries by enabling the extraction of valuable insights from data. In recent years, its applications in the field of chemical engineering have witnessed significant growth, transforming the way processes are modeled, monitored, and optimized. Examples include an artificial intelligence (AI) framework integrating a physics-informed neural network with predictive control, which applies neural networks in the chemical engineering domain. Conventional models have been evaluated as a high-fidelity and fast energy management model and was successfully implemented in a tomato cultivation environment, neural networks for soft sensor development, a deep neural network (DNN)-based prediction model for the steam methane reforming process, widely used for hydrogen production.

Despite the above efforts for ML application to the chemical engineering field, some limitations still remain. The chemical industry requires much time and cost to collect sufficient high-quality data. Thus, the number of data may not be enough for data-driven modeling, which causes overfitting issue in the model training process. In addition, the model performance depends on the initial parameters of neural networks when using a small number of data. As a result, the data-driven models can show poor reliability and reproducibility in the chemical industry.

In this context, quantum machine learning provides a promising and interesting route, for example, using different parameterized quantum circuits (PQC), also known as quantum neural network (QNN), as machine learning models for a variety of data-driven tasks, such as supervised learning and generative modeling. Such QNN can be trained similarly to classical neural networks and show good expressive power, depending on the architecture and dataset. Recently, there has been a plethora of industrial use cases where quantum machine learning and quantum computing are being used successfully to provide prototype solutions to real-world business problems in the fields of finance, healthcare and pharmaceutical, materials, computer vision and supply chain industry.

Therefore, there is need for methods and systems for providing solutions to chemical engineering problems, where there is not a sufficient amount of high-quality data, using quantum machine learning and quantum computing.

### SUMMARY

Embodiments of the present disclosure provide a method of performing computation in a hybrid quantum-classical computing system including a classical computer and a quantum processor. The method includes executing one or more iterations, each iteration including receiving, by a classical computer, one or more input features of a training sample in a first classical neural network, computing, by the classical computer, a plurality of first outputs from the first classical neural network based on a plurality of first trainable parameters, setting, by a system controller, a quantum processor in an initial state, the quantum processor including a plurality of trapped ions, each of which has two hyperfine states defining a qubit, applying, by the system controller, a parametrized quantum circuit to the quantum processor based on the plurality of first outputs and a set of variational parameters, the parametrized quantum circuit including one or more encoding layer circuits based on the plurality of first outputs, and one or more trainable layer circuits based on the set of variational parameters, and measuring, by the system controller, qubit states of the quantum processor, receiving, by the classical computer, measured expectation values of the qubit states of the quantum processor in a second classical neural network, computing, by the classical computer, a plurality of second outputs from the second classical neural network based a plurality of second trainable parameters, adjusting, by the classical computer, the plurality of first trainable parameters, the plurality of second trainable parameters, and the set of variational parameters, and outputting, by the classical computer, the plurality of first trainable parameters, the plurality of second trainable parameters, and the set of variational parameters.

Embodiments of the present disclosure also provide a hybrid quantum neural network (QNN) implemented in a hybrid quantum-classical computing system including a classical computer and a quantum processor including a plurality of qubits. The hybrid QNN includes a first classical neural network implemented by a classical computer and configured to receive one or more input features of a training sample and compute first outputs based on a plurality of first trainable parameters, a quantum neural network implemented by a quantum processor including a plurality of qubits, and configured to receive the first outputs from the first classical neural network and compute outputs, the quantum neural network including a preparation operation gate to set, by a system controller, the quantum processor in an initial state, a parametrized quantum circuit including one or more encoding layer circuits, each including single qubit rotation gates individually applied, by the system controller, to the plurality of qubits to encode the outputs from the first classical neural network in rotation angles of the single qubit rotation gates, one or more trainable layer circuits, each including single qubit rotation gates individually applied to the plurality of qubits and CNOT gates applied to pairs of the plurality of qubits, and a measurement operation gate to measure, by the system controller, qubit states of the quantum processor, and a second classical neural network implemented by the classical computer and configured to receive measured expectation values of the qubit states of the quantum processor and compute second outputs based on a plurality of second trainable parameters.

Embodiments of the present disclosure further provide a hybrid quantum-classical computing system. The hybrid quantum-classical computer system includes a quantum processor including a plurality of trapped ions, each of the trapped ions having two hyperfine states defining a qubit, one or more lasers configured to emit a laser beam controlled by a system controller, which is provided to trapped ions in the quantum processor, and a classical computer configured to execute one or more iterations, each iteration including receiving one or more input features of a training sample in a first classical neural network, computing a plurality of first outputs from the first classical neural network based on a plurality of first trainable parameters, controlling the system controller to set a quantum processor in an initial state, controlling the system controller to apply a parametrized quantum circuit to the quantum processor based on the plurality of first outputs and a set of variational parameters, the parametrized quantum circuit including one or more encoding layer circuits based on the plurality of first outputs, and one or more trainable layer circuits based on the set of variational parameters, and measuring, by the system controller, qubit states of the quantum processor, receiving measured expectation values of the qubit states of the quantum processor in a second classical neural network, computing a plurality of second outputs from the second classical neural network based a plurality of second trainable parameters, adjusting the plurality of first trainable parameters, the plurality of second trainable parameters, and the set of variational parameters, and output the plurality of first trainable parameters, the plurality of second trainable parameters, and the set of variational parameters.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic partial view of an ion trap quantum computing system according to one embodiment.

FIG. 2A depicts a schematic energy diagram of each ion in an ion chain according to one embodiment.

FIG. 2B depicts a schematic motional sideband spectrum of an ion in an ion chain according to one embodiment.

FIG. 3 depicts a flow illustrating a naphtha cracking process.

FIG. 4 depicts a classical artificial neural network (ANN) used as a comparison with a hybrid quantum neural network (QNN) according to the embodiments described herein.

FIG. 5 depicts a hybrid quantum neural network (QNN) according to the embodiments described herein.

FIG. 6 depicts a flowchart illustrating a method 600 of training a hybrid QNN depicted in FIG. 5 to solve a ML modeling problem in a chemical engineering process, according to one or more embodiments of the present disclosure.

FIG. 7 depicts the coefficient of determinants (R²) of the test dataset against the number of epochs.

FIGS. 8A and 8B illustrate the model performance in terms of robustness to small training set sizes via coefficient of determinants (R²) and root mean square (RMSE) values.

FIGS. 9A and 9C show performance of the trained model on test data from a single experiment.

FIGS. 9B and 9D show performance of multiple trained models on test data, where each model is initialized randomly.

To facilitate understanding, identical reference numerals have been used, where possible, to designate identical elements that are common to the figures. In the figures and the following description, an orthogonal coordinate system including an X-axis, a Y-axis, and a Z-axis is used. The directions represented by the arrows in the drawing are assumed to be positive directions for convenience. It is contemplated that elements disclosed in some embodiments may be beneficially utilized on other implementations without specific recitation.

### DETAILED DESCRIPTION

The embodiments described herein provide a system and a method of solving machine learning (ML) modeling problems in chemical engineering processes using a hybrid quantum neural network that is a combination of a classical artificial neural network and a quantum neural network. The hybrid quantum neural network has shown to have better prediction performance than a classical neural network, when trained with the same training sample, even with a small training sample size, at a faster training speed.

In the hybrid QNN according to the embodiments described herein, input features of a training sample is fed to a classical neural network first, instead of directly to a quantum neural network. The size of the input features is reduced via the classical neural network before fed to the quantum neural network, the required number of qubits in the quantum neural network is reduced, and thus the quantum neural network can be used in currently available quantum computers that may be noisy and prone to errors, while providing acceleration in solving ML modeling problems.

### General Hardware Configurations

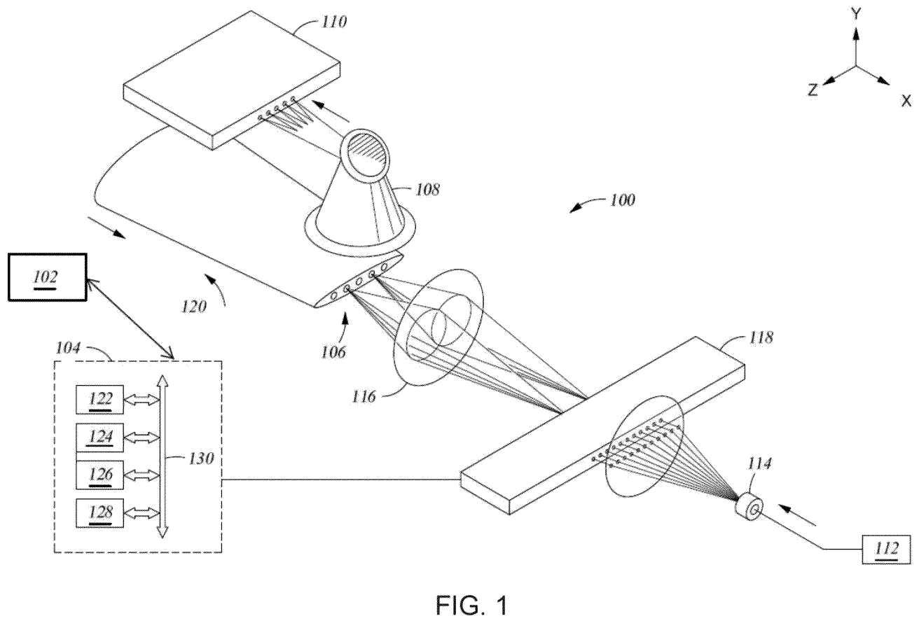

FIG. 1 is a schematic partial view of an ion trap quantum computing system, or system 100, according to one embodiment. The system 100 includes a classical (digital) computer 102, a system controller 104 and a quantum processor that is an ion chain 106 having trapped ions (i.e., five shown) that extend along the Z-axis. The classical computer 102 includes a central processing unit (CPU), memory, and support circuits (or I/O). The memory is connected to the CPU, and may be one or more of a readily available memory, such as a read-only memory (ROM), a random access memory (RAM), floppy disk, hard disk, or any other form of digital storage, local or remote. Software instructions, algorithms and data can be coded and stored within the non-volatile memory for instructing the CPU. The support circuits (not shown) are also connected to the CPU for supporting the processor in a conventional manner. The support circuits may include conventional cache, power supplies, clock circuits, input/output circuitry, subsystems, and the like.

An imaging objective 108, such as an objective lens with a numerical aperture (NA), for example, of 0.37, collects fluorescence along the Y-axis from the ions and maps each ion onto a multi-channel photo-multiplier tube (PMT) 110 for measurement of individual ions. Non-copropagating Raman laser beams from a laser 112, which are provided along the X-axis, perform operations on the ions. A diffractive beam splitter 114 creates an array of static Raman beams 116 that are individually switched using a multi-channel acousto-optic modulator (AOM) 118 and is configured to selectively act on individual ions. A global Raman laser beam 120 illuminates all ions at once. The system controller (also referred to as a “RF controller”) 104 controls the AOM 118 and thus controls laser pulses to be applied to trapped ions in the ion chain 106. The system controller 104 includes a central processing unit (CPU) 122, a read-only memory (ROM) 124, a random access memory (RAM) 126, a storage unit 128, and the like. The CPU 122 is a processor of the system controller 104. The ROM 124 stores various programs and the RAM 126 is the working memory for various programs and data. The storage unit 128 includes a nonvolatile memory, such as a hard disk drive (HDD) or a flash memory, and stores various programs even if power is turned off. The CPU 122, the ROM 124, the RAM 126, and the storage unit 128 are interconnected via a bus 130. The system controller 104 executes a control program which is stored in the ROM 124 or the storage unit 128 and uses the RAM 126 as a working area. The control program will include software applications that include program code that may be executed by processor in order to perform various functionalities associated with receiving and analyzing data and controlling any and all aspects of the methods and hardware used to create the ion trap quantum computer system 100 discussed herein.

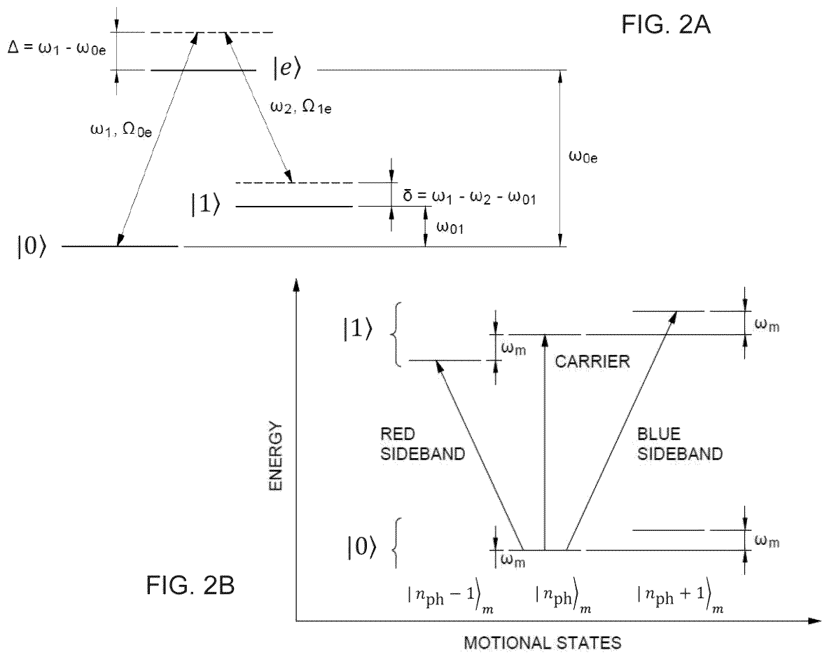

FIG. 2A depicts a schematic energy diagram of each ion in the ion chain 106 according to one embodiment. In one example, each ion may be a positive Ytterbium ion, ¹⁷¹Yb⁺, which has the ²S_{1/2} hyperfine states (i.e., two electronic states) with an energy split corresponding to a frequency difference (referred to as a “carrier frequency”) of ω₀₁/2π=12.6 GHz. A qubit is formed with the two hyperfine states, used to represent computational basis |0 [symbol] and |1 [symbol] (|i [symbol] (i∈Z)), where the hyperfine ground state (i.e., the lower energy state of the ²S_{1/2} hyperfine states) is chosen to represent |0 [symbol] . Hereinafter, the terms “hyperfine states,” “internal hyperfine states,” and “qubit states” may be interchangeably used to represent computational basis states |0 [symbol] and |1 [symbol] (|i [symbol] (i∈Z)). Each ion may be cooled (i.e., kinetic energy of the ion may be reduced) to near the motional ground state |0 [symbol] ₘ for any motional mode m with no phonon excitation (i.e., nₚₕ=0) by known laser cooling methods, such as Doppler cooling or resolved sideband cooling, and then the qubit state prepared in the hyperfine ground state |0 [symbol] by optical pumping. Here, |0 [symbol] represents the individual qubit state of a trapped ion whereas |0 [symbol] ₘ with the subscript m denotes the motional ground state for a motional mode m of the ion chain 106.

An individual qubit state of each trapped ion may be manipulated by, for example, a mode-locked laser at 355 nanometers (nm) via the excited ²P_{1/2} level (denoted as |e [symbol] ). As shown in FIG. 2A, a laser beam from the laser may be split into a pair of non-copropagating laser beams (a first laser beam with frequency ω₁ and a second laser beam with frequency ω₂) in the Raman configuration, and detuned by a one-photon transition detuning frequency Δ=ω₁−ω₀ₑ with respect to the transition frequency ωde between |0 [symbol] and |e [symbol] , as illustrated in FIG. 2A. A two-photon transition detuning frequency δ includes adjusting the amount of energy that is provided to the trapped ion by the first and second laser beams, which when combined is used to cause the trapped ion to transfer between the hyperfine states |0 [symbol] and |1 [symbol] . When the one-photon transition detuning frequency Δ is much larger than a two-photon transition detuning frequency (also referred to simply as “detuning frequency”) δ=ω₁−ω₂−ω₀₁ (hereinafter denoted as ±μ, μ being a positive value), single-photon Rabi frequencies Ω₀ₑ(t) and Ω₁ₑ(t) (which are time-dependent, and are determined by amplitudes and phases of the first and second laser beams), at which Rabi flopping between states |0 [symbol] and |e [symbol] and between states |1 [symbol] and |e [symbol] respectively occur, and a spontaneous emission rate from the excited state |e [symbol] , Rabi flopping between the two hyperfine states |0 [symbol] and |1 [symbol] (referred to as a “carrier transition”) is induced at the two-photon Rabi frequency Ω(t). The two-photon Rabi frequency Ω(t) has an intensity (i.e., absolute value of amplitude) that is proportional to Ω₀ₑΩ₁ₑ/2Δ, where Ω₀ₑ and Ω₁ₑ are the single-photon Rabi frequencies due to the first and second laser beams, respectively. Hereinafter, this set of non-copropagating laser beams in the Raman configuration to manipulate internal hyperfine states of qubits (qubit states) may be referred to as a “composite pulse” or simply as a “pulse,” and the resulting time-dependent pattern of the two-photon Rabi frequency Ω(t) may be referred to as an “amplitude” of a pulse or simply as a “pulse,” which are illustrated and further described below. The detuning frequency δ=ω₁−ω₂−Ω₀₁ may be referred to as detuning frequency of the composite pulse or detuning frequency of the pulse. The amplitude of the two-photon Rabi frequency Ω(t), which is determined by amplitudes of the first and second laser beams, may be referred to as an “amplitude” of the composite pulse.

It should be noted that the particular atomic species used in the discussion provided herein is just one example of atomic species which has stable and well-defined two-level energy structures when ionized and an excited state that is optically accessible, and thus is not intended to limit the possible configurations, specifications, or the like of an ion trap quantum computer according to the present disclosure. For example, other ion species include alkaline earth metal ions (Bet, Cat, Sr⁺, Mg⁺, and Ba⁺) or transition metal ions (Zn⁺, Hg⁺, Cd⁺).

FIG. 2B depicts a schematic motional sideband spectrum of each ion in the ion chain 106 in a motional mode |nₚₕ [symbol] _{M} having frequency ωₘ according to one embodiment. As illustrated in FIG. 2B, when the detuning frequency of the composite pulse is zero (i.e., a frequency difference between the first and second laser beams is tuned to the carrier frequency, δ=ω₁−ω₂−ω₀₁=0), simple Rabi flopping between the qubit states |0 [symbol] and |1 [symbol] (carrier transition) occurs. When the detuning frequency of the composite pulse is positive (i.e., the frequency difference between the first and second laser beams is tuned higher than the carrier frequency, δ=ω₁−ω₂−ω₀₁=μ>0, referred to as a blue sideband), Rabi flopping between combined qubit-motional states |0 [symbol] |nₚₕ [symbol] ₘ and |1 [symbol] |nₚₕ+1 [symbol] ₘ occurs (i.e., a transition from the m-th motional mode with n-phonon excitations denoted by |nₚₕ [symbol] ₘ to the m-th motional mode with (nₚₕ+1)-phonon excitations denoted by |nₚₕ+1 [symbol] ₘ occurs when the qubit state |0 [symbol] flips to |1 [symbol] ). When the detuning frequency of the composite pulse is negative (i.e., the frequency difference between the first and second laser beams is tuned lower than the carrier frequency by the frequency ωₘ of the motional mode |nₚₕ [symbol] ₘ, δ=ω₁−ω₂−ω₀₁=−μ<0, referred to as a red sideband), Rabi flopping between combined qubit-motional states |0 [symbol] |nₚₕ [symbol] ₘ and |1 [symbol] |nₚₕ−1 [symbol] ₘ occurs (i.e., a transition from the motional mode |nₚₕ [symbol] ₘ to the motional mode |nₚₕ−1 [symbol] ₘ with one less phonon excitations occurs when the qubit state |0 [symbol] flips to |1 [symbol] ). A π/2-pulse on the blue sideband applied to a qubit transforms the combined qubit-motional state |0 [symbol] |nₚₕ [symbol] ₘ into a superposition of |0 [symbol] |nₚₕ [symbol] ₘ and |1 [symbol] |nₚₕ+1 [symbol] ₘ. A π/2-pulse on the red sideband applied to a qubit transforms the combined qubit-motional |0 [symbol] |nₚₕ [symbol] ₘ into a superposition of |0 [symbol] |nₚₕ [symbol] ₘ and |1 [symbol] |nₚₕ−1 [symbol] ₘ. When the two-photon Rabi frequency Ω(t) is smaller as compared to the detuning frequency δ=ω₁−ω₂−ω₀₁=±μ, the blue sideband transition or the red sideband transition may be selectively driven. Thus, qubit states of a qubit can be entangled with a desired motional mode by applying the right type of pulse, such as a π/2-pulse, which can be subsequently entangled with another qubit, leading to an entanglement between the two qubits that is needed to perform an XX-gate operation in an ion trap quantum computer.

### Hybrid Quantum Neural Network on Hybrid Quantum-Classical Computing System

While currently available quantum computers may be noisy and prone to errors, a combination of both quantum and classical computers, in which a quantum computer is a domain-specific accelerator, can be used to solve machine learning (ML) modeling problems in chemical engineering processes that are beyond the reach of classical computers.

However, ML is also highly data-dependent, and its generalization performance could be poor when data is insufficient. Among the various quantum computing techniques that have emerged recently, parametrized quantum circuit (PQC), also known as quantum neural network (QNN), has been reported to have excellent generalization performance when data is insufficient.

The embodiments described herein provide a hybrid quantum neural network (QNN) combining quantum neural network (QNN) with artificial neural network (ANN) to further improve generalization performance when data is insufficient.

In the examples shown below, the hybrid QNN is applied to a naphtha cracking process using actual industrial data to predict ethylene (EL) yield and propylene (PL) yield in the naphtha cracking process. The performance of the hybrid QNN was compared with an ANN using the same data. As shown below, the results show that the hybrid QNN performs better than the ANN regarding a training rate and generalization ability when data is insufficient. When trained with initial parameters that are changed randomly for different train data sizes, hybrid QNNs consistently produced higher accuracy predictions than ANNs. The difference in performance between hybrid QNN and ANN was particularly large when the data was small.

The hybrid QNN according to the embodiments described herein includes a high-fidelity model that can be used to solve ML modeling problems that traditionally had a poor result reliability and reproducibility and the hybrid QNN can be used to solve other chemical engineering problems which have insufficient data.

### Naphtha Cracking Process

The naphtha cracking process has been widely applied in the chemical industry due to its direct impact on the production of high-value chemicals. The naphtha cracking plays a pivotal role in the petrochemical industry, as it serves as a critical source for the production of ethylene (EL) and propylene (PL). These two compounds are essential building blocks for a wide range of chemical products and hold significant economic importance.

It is crucial to predict the yields of the main product, because the predicted values serve as valuable guides for operators, enabling them to effectively control and optimize operational conditions. Nonetheless, the task of predicting product yield is challenging due to the complex chemical reactions, process fluctuations, and the necessity for real-time monitoring.

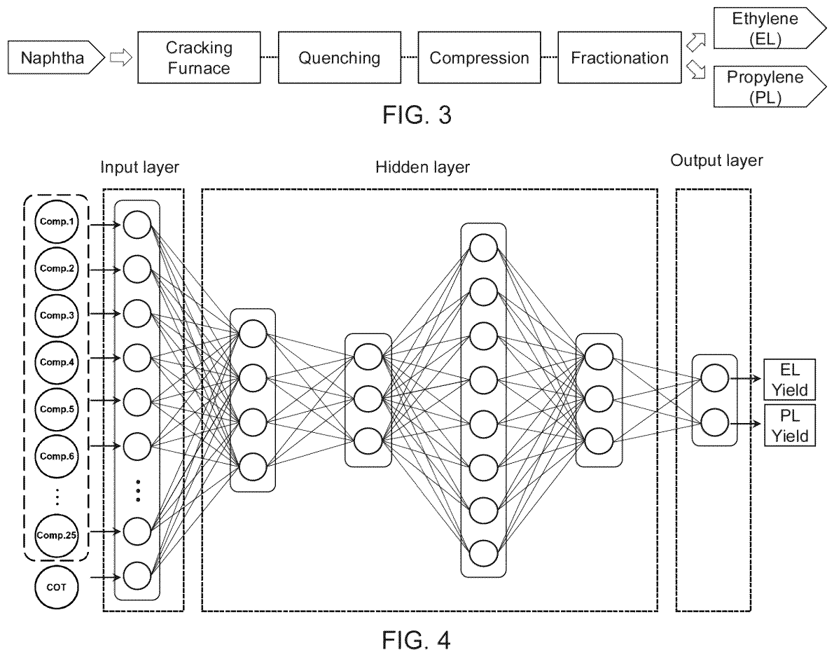

The naphtha cracking process includes four units: a cracking furnace process, a quenching process, a compression process, and a fractionation unit process, as shown in FIG. 3. First, naphtha is cracked into a hydrocarbon mixture including ethylene (EL) yield and propylene (PL) via the cracking furnace process. In this step, most heavy hydrocarbons are cracked into the light hydrocarbons because heat energy from the furnace causes the cracking reactions. After the cracking process, the product gas, such as EL and PL, is quenched to prevent coke formation which reduces process efficiency. Moreover, waste heat recovery is conducted which increases the process efficiency. Then, the product gas receives energy to be transferred into the fraction unit. In this step, the quenched gas is compressed under high pressure which helps economical separation. Finally, the product gas is separated into several useful products, such as hydrogen, EL, and PL.

Although the four units are crucial in the naphtha cracking process, the cracking furnace process has a considerable impact on the product yield because the initial product gas is generated in the furnace. Thus, the operating conditions of the cracking furnace are very important to increase the yield of main products. There are two key variables, composition of naphtha and coil outlet temperature (COT). The naphtha composition is significant because each component has a different activation energy for the cracking reaction, which means the product yield depends on the composition under the same operating conditions. Second, COT is crucial to increase product yield because it is an indicator of how much energy is applied to the cracking reaction.

### Data Description and Pre-Processing

The dataset was provided from a real naphtha cracking plant located in South Korea. Table 1 illustrates the data structure including the number of data and features. The total number of training samples is 784, the number of input features in each training sample is 26 including 25 compositions and COT, and the number of output features is 2 including the yields of EL and PL.

TABLE 1
The data structure of the operating cracking furnace

| Case | Comp. 1 | Comp. 2 | . . . | Comp. 25 | COT | EL | PL |
|---|---|---|---|---|---|---|---|
| Case 1 | 3.85 | 4.55 | . . . | 0.08 | 806 | 26.12 | 17.93 |
| Case 2 | 2.89 | 5.61 | . . . | 0.00 | 802 | 25.79 | 18.30 |
| . . . | . . . | . . . | . . . | . . . | . . . | . . . | . . . |
| Case 784 | 3.31 | 7.03 | . . . | 0.00 | 814 | 27.37 | 16.82 |

In real-world datasets, data scales depend on the various variables, which has a considerable impact on the model training process. Thus, it is essential to normalize data before performing data-driven modeling. Among many scaling techniques, min-max scaling, one of the common techniques, has been used in this example. Min-max scaler transforms each feature individually such that it is in the given range on the training set, e.g. between zero and one as shown in Eq. (1)

$${x}_{i}^{′} = \frac{{x}_{i} - min ( x )}{max ( x ) - min ( x )} \qquad ( 1 )$$

where x′ᵢ is the scaled feature, xᵢ is the original input feature, min(x) and max(x) is the minimum and maximum values of the input feature x.

### Artificial Neural Network (ANN)

FIG. 4 depicts a classical artificial neural network (ANN) used as a comparison with a hybrid quantum neural network (QNN) according to the embodiments described herein. The ANN includes an input layer, one or more hidden layers, and an output layer, and each layer includes perceptrons (shown as open circles in FIG. 4), which is the basic unit of a neural network. Each layer is fully connected to the next layer via connections (shown as lines between pairs of open circles in FIG. 4) between the layers, where each of the connections is assigned with a weight value and a bias value. The ANN is trained on training samples, such as the dataset shown in Table 1, each training sample including one or more input features (e.g., 25 components and COT) associated with actual output features (e.g., yields of EL and PL), to correctly predict output features when input features in a training sample are fed into the ANN, by a forward propagation process and a backward propagation process. In a forward propagation process, training samples are passed through the ANN in order from the input layer to the output layer. In a backward propagation process, weights of the connections between layers are updated based on differences between the actual output features and the output features predicted by the ANN in the forward propagation process.

In a forward propagation process, the input features of a training sample are encoded in perceptrons of the input layer, and passed to a next layer (e.g., a hidden layer). During the passing of the input features to the next layer, the input features are multiplied by weight values assigned to the connections and added bias values assigned to the connections, and passed to the next layer through an activation function. Outputs from a hidden layer are passed to a next hidden layer similarly, and finally to the output layer. Outputs from the output layer are output features predicted by the ANN in the forward propagation process, and are compared with actual features of the training sample. Batches of data are iteratively passed through the ANN, and the weight values are updated such that the differences between the predicted output features and the actual output features are decreased. In this backward propagation process, the weight values assigned to the connections between layers are updated from the last layer to the previous layer in turn based on an approximate derivative of the difference between the predicted and actual output features with weight values. That is, a weight value (which is a trainable parameter) θ is updated, as represented by:

$$Θ \to Θ - η \frac{\partial L}{\partial Θ} \qquad ( 2 )$$

where η is a learning rate, and L is a loss function. To minimize the loss function L, an optimizer algorithm is used.

The ANN with the weight values assigned to the connections between layers that were updated as above after the training process on the training samples can be used to correctly predict output features when input features are fed into the ANN.

In the example of the ANN shown in FIG. 4, the input layer includes 26 perceptrons to receive 26 inputs (including 25 components and COT), and the output layer includes 2 perceptrons to provides two outputs mapped to EL yield and PL yield, respectively. Between the input layer and the output layers, there are three hidden layers having 4 perceptrons, 3 perceptrons, 8 perceptrons, and 3 perceptrons, respectively. The activation function is a hyperbolic tangent function, the learning rate n is set to 0.001, the optimizer algorithm is Adam, and the loss function L is a mean squared error (MSE) function.

### Hybrid Quantum Neural Network (QNN)

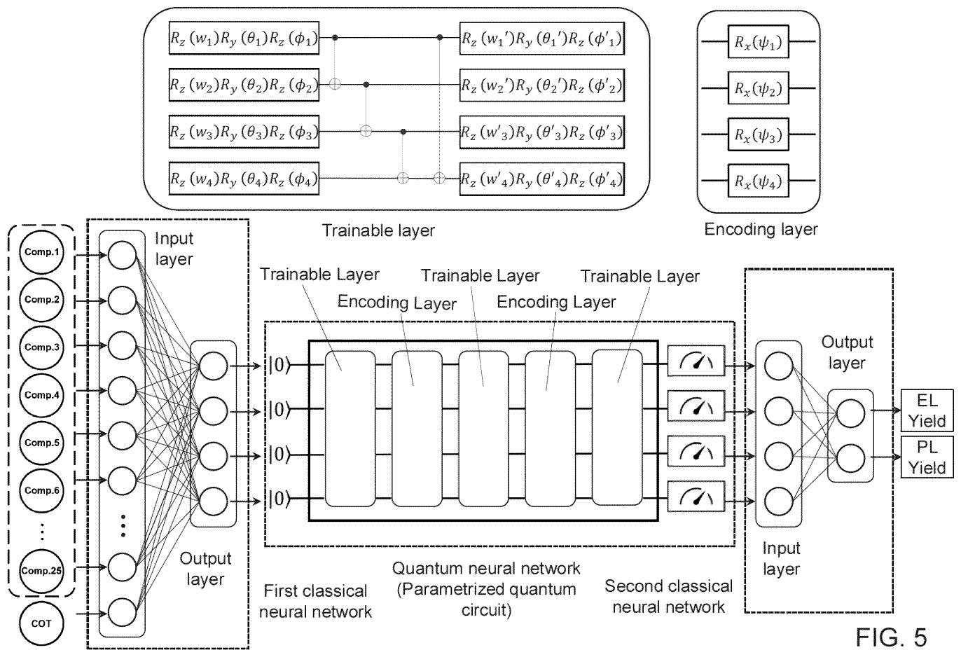

FIG. 5 depicts a hybrid quantum neural network (QNN) according to the embodiments described herein. The hybrid QNN includes a first classical neural network (NN), a quantum neural network (QNN), and a second classical neural network (NN). The hybrid QNN is trained on training samples, such as the dataset shown in Table 1, each training sample including one or more input features (e.g., 25 components and COT) associated with actual output features (e.g., yields of EL and PL), to correctly predict output features when input features of a training sample are fed into the hybrid QNN.

The first classical NN, including an input layer and an output layer, is implemented by a classical computer, such as the classical computer 102. Each layer of the first classical NN includes perceptrons (shown as open circles in FIG. 5). The input layer and the output layer are fully connected via connections (shown as lines between pairs of open circles in FIG. 5) between the input layer and the output layer, where each of the connections is assigned with a weight value and a bias value. The first classical NN receives input features of a training sample and computes outputs to pass to the QNN.

The second classical NN, including an input layer and an output layer, is implemented by a classical computer, such as the classical computer 102. Each layer of the second classical NN includes perceptrons (shown as open circles in FIG. 5). The input layer and the output layer are fully connected via connections (shown as lines between pairs of open circles in FIG. 5) between the input layer and the output layer, where each of the connections is assigned with a weight value and a bias value. The second classical NN receives outputs from the quantum neural network and computes outputs, which are output features predicted by the hybrid quantum neural network.

The QNN including a preparation operation gate, a parametrized quantum circuit constructed based on a set of variational parameters, and a measurement operation gate, is implemented by a quantum processor, such as the ion chain 106 of n trapped ions. The QNN receives the outputs of the first classical NN and computes outputs to pass to the second classical NN.

The hybrid QNN is trained on training samples, such as the dataset shown in Table 1, each training sample including one or more input features (e.g., 25 components and COT) associated with actual output features (e.g., yields of EL and PL), to correctly predict output features when input features of a training sample are fed into the hybrid QNN, by a forward propagation process and a backward propagation process. In a forward propagation process, training samples are passed through the hybrid QNN in order from the first classical NN to the second classical NN through the QNN. In a backward propagation process, trainable parameters, including weight values and bias values of the perceptrons of each layer of the first classical NN and the second classical NN and the parameters in the parametrized quantum circuit, are updated based on the output features predicted by the hybrid QNN in the forward propagation process.

In a forward propagation step, the input features of a training sample are encoded in perceptrons of the input layer of the first classical NN, and passed to the output layer. During the passing of the input features to the output layer, the input features are multiplied by weight values assigned to the connections and added bias values assigned to the connections, and passed to the output layer through an activation function. The QNN receives outputs from the first classical NN and passes outputs from the QNN to the second classical NN. The outputs from the QNN are encoded in perceptrons of the input layer of the second classical NN, and passed to the output layer. During the passing of the outputs from the QNN to the output layer, the outputs from the QNN are multiplied by weight values assigned to the connections and added bias values assigned to the connections, and passed to the output layer through an activation function. The outputs obtained from the second classical NN, which output features predicted by the hybrid NN, are compared with actual output features of the training sample. Based on differences between the predicted output features and the actual output features, batches of data (e.g., differences between the predicted output features and the actual output features of multiple training samples) are iteratively passed through the hybrid QNN in order from the second classical NN to the first classical NN, and the trainable parameters are updated such that the differences are decreased. In this backward propagation process, the trainable parameters are updated from the last layer to the previous layer in turn based on an approximate derivative of the difference between the predicted output features and actual output features with the trainable parameters.

The trainable parameters θ including the weight values and the bias values in the first classical NN and the weight values in the second classical NN are updated according to Equation (2). The trainable parameters θ in the QNN (e.g., a set of variational parameters) are updated according to:

$${∇}_{Θ} 〈 \hat{B} 〉 ( Θ ) = \frac{1}{2} [ 〈 \hat{B} 〉 ( Θ + \frac{π}{2} \hat{e} ) - 〈 \hat{B} 〉 ( Θ + \frac{π}{2} \hat{e} ) ] \qquad ( 3 )$$

where \hat{B} represents the projection of the qubit states onto y-axis and (\hat{B}) represents an expectation value of the qubit states projected onto y-axis.

In the example of the hybrid QNN shown in FIG. 5, the input layer of the first classical NN includes 26 perceptrons to receive 26 input features (including 25 components and COT), and the output layer of the second classical NN includes 2 perceptrons to provides two outputs mapped to EL yield and PL yield, respectively. The output layer of the first classical NN includes 4 perceptrons and provides 4 outputs to the QNN. The input layer of the second classical NN includes 4 perceptrons to receive 4 outputs from the QNN. The activation function is a hyperbolic tangent function, the learning rate n is set to 0.001, the optimizer algorithm was Adam, and the loss function L is a mean squared error (MSE) function.

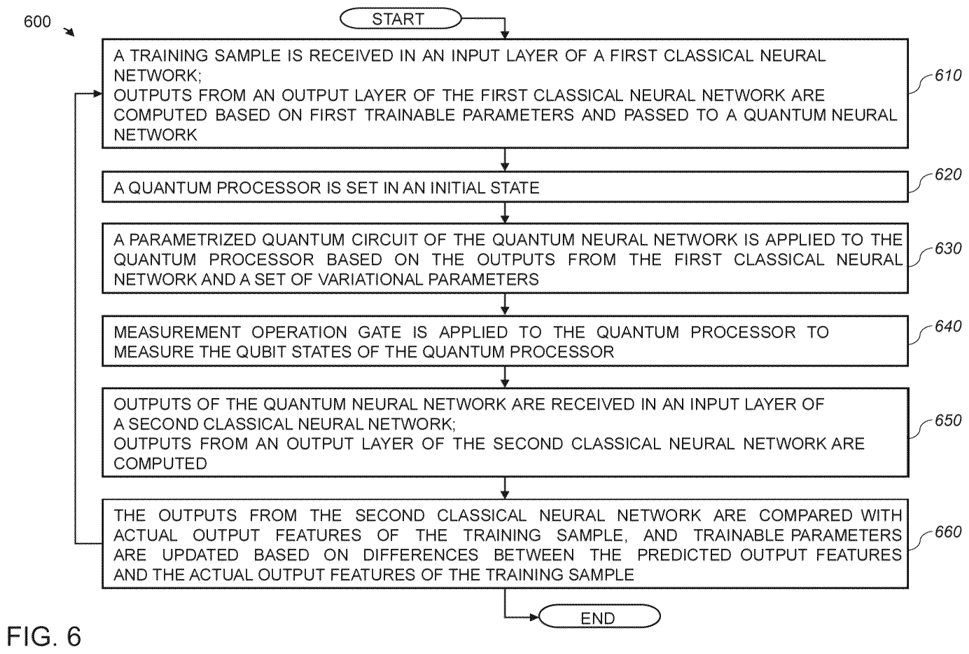

FIG. 6 depicts a flowchart illustrating a method 600 of training a hybrid QNN depicted in FIG. 5 to solve a ML modeling problem in a chemical engineering process, according to one or more embodiments of the present disclosure. In this example, a quantum processor is the ion chain 106 of n trapped ions, in which the two hyperfine states of each of the n trapped ions form a qubit, for example, the hyperfine ground state representing qubit state |0 [symbol] and the hyperfine excited state representing qubit state | 1 [symbol] .

The hybrid QNN includes multiple trainable parameters that are adjusted from initial values to trained values. To train the hybrid QNN, the hybrid QNN first receives multiple training samples, such as the dataset shown in Table 1, each training sample including one or more input features (e.g., 25 components and COT) associated with actual output features (e.g., yields of EL and PL). The hybrid QNN then processes input features and predicts output features. The predicted output features are then compared with the actual output features of the training samples. Based on differences between the predicted output features and the actual output features, the trainable parameters of the hybrid QNN are adjusted such that the difference will decrease.

The method 600 begins with block 610, in which, by a classical computer, such as the classical computer 102, a training sample is received in the input layer of the first classical NN, and outputs from the output layer of the first classical NN are computed and passed to the QNN.

The input features of the training sample are encoded in perceptrons of the input layer, and passed to the output layer via connections between all pairs of perceptrons of the input layer and perceptrons of the output layer. When the input features are passed from the input layer to the output layer, the input features are multiplied by weight values assigned to the connections and added bias values assigned to the perceptrons of the output layer. The weight values and the bias values are herein referred to as “first trainable parameters”. The output layer is thus fully connected to the input layer via the assigned weight values and the assigned bias (“first trainable parameters”). The weight values are initially randomly chosen, and then learned and updated during the training process.

In the example of the hybrid QNN shown in FIG. 5, where training samples are taken from the dataset shown in Table 1, the input layer includes 26 perceptrons to receive 26 input features (including 25 components and COT), and the output layer includes 4 perceptrons to compute 4 outputs. The number of connections between the input layer and the output layer is 26×4=104, and thus the number of weights associated with those connections is 104. Thus, the number of the first trainable parameters is 104+4=108, where the number of bias values as assigned to the perceptrons of the output layer is 4. The number of the perceptrons in the output layer of the first classical NN is chosen to reduce the number of input features to be fed to the QNN, and thus a faster training on the QNN can be achieved. The number is not limited to 4, and can be any number between the number of input features (e.g., 26) and the number of output features (e.g., 2).

In block 620, by a system controller, such as the system controller 104, a preparation operation gate is applied to the quantum processor to set the quantum processor in an initial state |Ψ₀ [symbol] . In some embodiments, the initial state |Ψ₀ [symbol] may be in the hyperfine ground state of the quantum processor (in which all qubits are in the hyperfine ground state |0 [symbol] ).

In block 630, by the system controller, a parametrized quantum circuit (PQC) of the QNN is applied to the quantum processor based on the outputs from the first classical neural network and a set of variational parameters. The PQC includes a series of alternate and iterative applications of encoding layer circuits and trainable layer circuits. In some embodiments, the trainable layer circuit is applied to the quantum processor first, followed by the encoding layer circuit, as shown in FIG. 5. In some other embodiments, the encoding layer circuit is applied to the quantum processor first, followed by the trainable layer circuit.

The encoding layer circuit includes single qubit rotation gates Rₓ(ψᵢ) (i=1, 2, . . . , n) about x-axis individually applied to qubits i (i=1, 2, . . . , n) and encodes the outputs from the first classical NN in rotation angles ψᵢ of qubits i (i=1, 2, . . . , n).

In the example of the hybrid QNN shown in FIG. 5, where training samples are taken from the dataset shown in Table 1, the number of outputs from the first classical NN is 4, and thus the number of qubits n in the QNN is 4.

The trainable layer circuit includes single qubit rotation gates U_{z,y,z}(θᵢ) (i=1, 2, . . . , n) about z, y, and z axes individually applied to qubits i (i=1, 2, . . . , n) and CNOT gates that are applied to pairs of qubits. A set of variational parameters is initially chosen randomly, and then learned and updated during the training process.

In the example of the hybrid QNN shown in FIG. 5, qubit states are first each changed by three rotation gates that rotate the qubits around the z, y, and z-axes in that order, then entangled by the CNOT gates, and again each changed by the three rotation gates. The rotation angles of the gates are trainable (variational), initialized randomly or with fixed angles. Thus, the number of variational parameters θ is 24. When the trainable layer circuit is applied three times, the total number of variational parameters θ in the PQC is 72.

In block 640, by the system controller, a measurement operation gate is applied to the quantum processor to measure the qubit states of the quantum processor after a layer of Hadamard gates on each qubit. Repeated measurement of populations of the trapped ions in the z-basis, by collecting fluorescence from each trapped ion and mapping onto the PMT 110, yields expectation (averaged) values of the qubit states projected onto y-axis, where each measurement provides 0 or 1 and thus an expectation value is between 0 and 1. The measured expectation values of the qubits are outputs from the QNN and passed to the second classical NN.

In block 640, by the system controller, a measurement operation gate is applied to the quantum processor to measure the qubit states of the quantum processor. Repeated measurement of populations of the trapped ions in about y-axis, by collecting fluorescence from each trapped ion and mapping onto the PMT 110, yields expectation (averaged) values of the qubit states projected onto y-axis, where each measurement provides 0 or 1 and thus an expectation value is between 0 and 1. The measured expectation values of the qubits are outputs from the QNN and passed to the second classical NN.

In block 650, by the classical computer, the outputs from the QNN are received in the input layer of the second classical NN and outputs from the output layer of the second classical NN are computed.

The outputs from the QNN are encoded in perceptrons of the input layer, and passed to the output layer via connections between all pairs of perceptrons of the hidden layer and perceptrons of the output layer. When the outputs from the QNN are passed from the input layer to the output layer, the outputs from the QNN are multiplied by assigned weight values (referred to as “second trainable parameters”). The weight values are initially randomly chosen, and then learned and updated during the training process.

In the example of the hybrid QNN shown in FIG. 5, the input layer includes 4 perceptrons to receive 4 outputs from the QNN, and the output layer includes perceptrons to compute 2 outputs, which are output features predicted by the hybrid QNN. The number of connections between the input layer and the output layer is 4×2=8, and thus the number of weights associated with those connections (“second trainable parameters”) is 8.

In block 660, by the classical computer, the predicted output features (the outputs from the second classical NN, and thus from the hybrid QNN) are compared with actual output features of the training sample. Based on differences between the predicted output features and the actual output features of the training sample, the trainable parameters θ, including the weights assigned to the connections between the input layer and the output layer and the bias values assigned to the perceptrons of the output layer of the first classical NN (“first trainable parameters”), the weights assigned to the connections between the input layer and the output layer of the second classical NN (“second trainable parameters”), and the variational parameters in the parametrized quantum circuit in the QNN, θ are updated, such that the differences between the predicted output features and the actual output features of the training sample are decreased.

The trainable parameters θ, including the weights assigned to the connections between the input layer and the input layer and the bias values assigned to the perceptrons of the output layer of the first classical NN (“first trainable parameters”) and the weights assigned to the connections between the input layer and the output layer of the second classical NN (“second trainable parameters”), are updated by the gradient descent method, represented by:

$$Θ \to Θ - η \frac{\partial L}{\partial Θ} \qquad ( 2 )$$

where η is a learning rate, and L is a loss function, such as a mean squared error (MSE) function. To minimize the loss function L, an optimizer algorithm, such as Adam, is used.

The trainable parameters θ including the variational parameters in the parametrized quantum circuit in the QNN, are updated according to:

$${∇}_{Θ} 〈 \hat{B} 〉 ( Θ ) = \frac{1}{2} [ 〈 \hat{B} 〉 ( Θ + \frac{π}{2} \hat{e} ) - 〈 \hat{B} 〉 ( Θ + \frac{π}{2} \hat{e} ) ] \qquad ( 3 )$$

where \hat{B} represents the projection of the qubit states onto y-axis and (\hat{B}) represents an expectation value of the qubit states projected onto y-axis.

The sequence of blocks 610 to 650 is iteratively repeated using another training sample based on the updated trainable parameters. The final trainable parameters after the training process on the training samples may be outputted, by the classical computer. The hybrid QNN with the final trainable parameters can be used to correctly predict output features when input features are fed into the hybrid QNN.

In the hybrid QNN according to the embodiments described herein, input features of a training sample are fed to a classical neural network first, instead of directly to a quantum neural network. The size of the input features is reduced via the classical neural network before fed to the quantum neural network, the required number of qubits in the quantum neural network is reduced, and thus the quantum neural network can be used in currently available quantum computers that may be noisy and prone to errors, while providing acceleration in solving ML modeling problems.

### Examples

To accurately compare hybrid QNN and ANN, a hybrid QNN and an ANN were trained under different conditions and their performances were compared. In comparison, 626 training samples, which are 80% of total 784 data samples, were used for training, and 158 data samples were used for testing. As shown in Table 2, in addition to training on all 626 training samples, case studies were conducted for training sample sizes of 100, 200, 300, 400, and 500. To verify that QNNs are known to be less volatile as a function of initial trainable parameters, the hybrid QNNs and ANNs were trained 30 times, each with randomly varying initial trainable parameter values. Both hybrid QNNs and ANNs were trained with 5000 epochs (the number of times a training sample passes through the hybrid QNN or the ANN) and a batch size of 32.

TABLE 2
Training process setup for hybrid QNNs and ANNs

| Parameters | Values |
|---|---|
| Initial trainable parameters | Random |
| Epochs | 5000 |
| Number of training processes | 30 |
| Total data sample size | 626 |
| Training sample sizes | 100, 200, 300, 400, 500, 626 |
| Batch size | 32 |
| Number of trainable parameters | 190 |

Table 3 shows coefficient of determinants (R²) and MSE, which are widely used to evaluate machine learning models in the chemical engineering, defined as

$${R}^{2} = 1 - \frac{{\sum }_{i = 1}^{n} {( {y}_{i} - {\hat{y}}_{i} )}^{2}}{{\sum }_{i = 1}^{n} {( {y}_{i} - {\overline{y}}_{i} )}^{2}} \qquad ( 4 )$$

$$M S E = \frac{1}{n} {\sum }_{i = 1}^{n} {( {y}_{i} - {\hat{y}}_{i} )}^{2} \qquad ( 5 )$$

where yᵢ is the actual output value, ŷᵢ is the predicted output value, and y̅ᵢ is the average value of the actual output values.

TABLE 3
The R² and MSE of Hybrid QNN and ANN

| | R² of EL | R² of PL | R² | MSE |
|---|---|---|---|---|
| Hybrid QNN | 0.9560 | 0.9852 | 0.9706 | 2.16e⁻⁶ |
| ANN | 0.9507 | 0.9854 | 0.9681 | 2.36e⁻⁶ |

It should be noted that the hybrid QNN shows a higher R² value for EL yield prediction, while the hybrid QNN shows similar R² value for PL yield prediction as the ANN. The total product yield prediction is better in the hybrid QNN, which shows 9.2% lower MSE than the ANN.

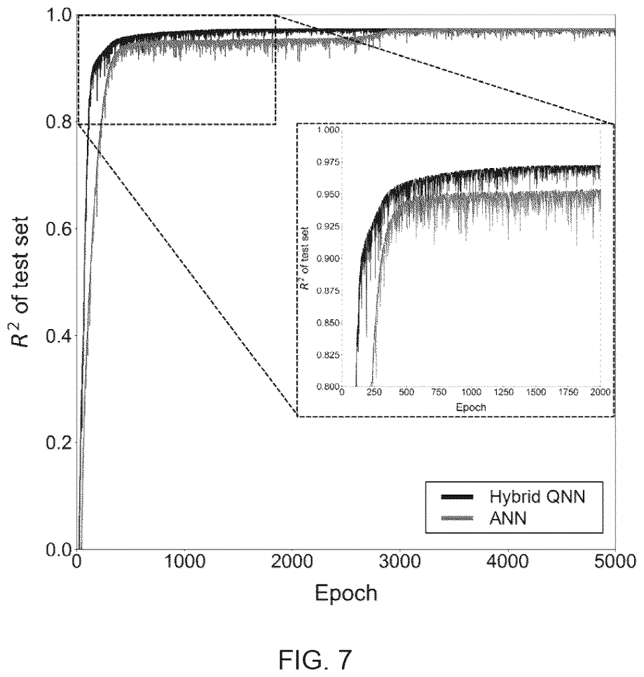

FIG. 7 depicts the coefficient of determinants (R²) of the test dataset against the number of epochs. As shown in FIG. 7, in the hybrid QNN, the R² value approaches approximately 0.9 before reaching 250 epochs, while in the ANN, a similar R² value is attained after 250 epochs. Furthermore, throughout the first 3000 epochs, the hybrid QNN consistently maintains a superiority over the ANN. This observation suggests that the Hybrid QNN model exhibits a faster convergence rate in comparison to the ANN model, ultimately resulting in fewer epochs for desired performance.

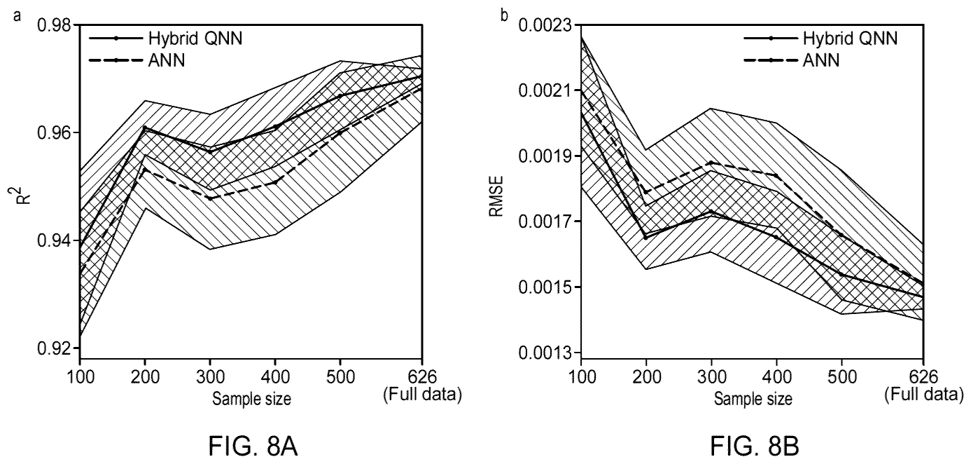

FIGS. 8A and 8B illustrate the model performance for a coefficient of determinants (R²) and root mean square (RMSE) values across different sample sizes for the hybrid QNN and ANN models. Y-axis shows different sizes of training set, where samples were drawn from the full training set. QNN models show higher mean R² value and lower RMSE value for smaller sizes of training dataset, compared classical ANN model. The blue and green lines within these figures represent the mean value derived from hybrid QNN and ANN models in 30 experiments. The shaded blue and green areas denote the associated STD of R² and RMSE values for these models. A comparative analysis of model performance has been made across various training sample sizes, ranging from 100 to 626, through 30 experiments. The blue and green lines within these figures represent the mean R² and RMSE values derived from hybrid QNN and ANN models in 30 experiments. The shaded blue and green areas denote the associated standard deviation (STD) of R² and RMSE values for these models. It has been observed as the training sample size increased, notable improvements in several key indicators. Specifically, R² showed increasing trends, indicating a more substantial alignment between predicted and actual values as the model had access to a larger pool of training data. Interestingly, the model performances drastically increased when 200 samples were used for the model training. This is because the potential similarity in data distributions between the training and test datasets. Additionally, the STD of R² and the STD of RMSE demonstrated reductions, suggesting increased reliability in model performance due to the greater information assimilated from the expanded training datasets during the model training process. It is observed that, for the most part, the mean values consistently exhibit higher values in the hybrid QNN model compared to the ANN model. This observation indicates that, even with relatively small sample sizes, the integration of QNN enhances the prediction performance of the neural network. Furthermore, it has been observed that the average STD of R² values for the ANN model (represented by the green area) tends to be larger than that of the hybrid QNN model (depicted by the blue area). This discrepancy underscores the ability of QNN to confer robustness to the neural network's initial parameters, contributing to its reliability.

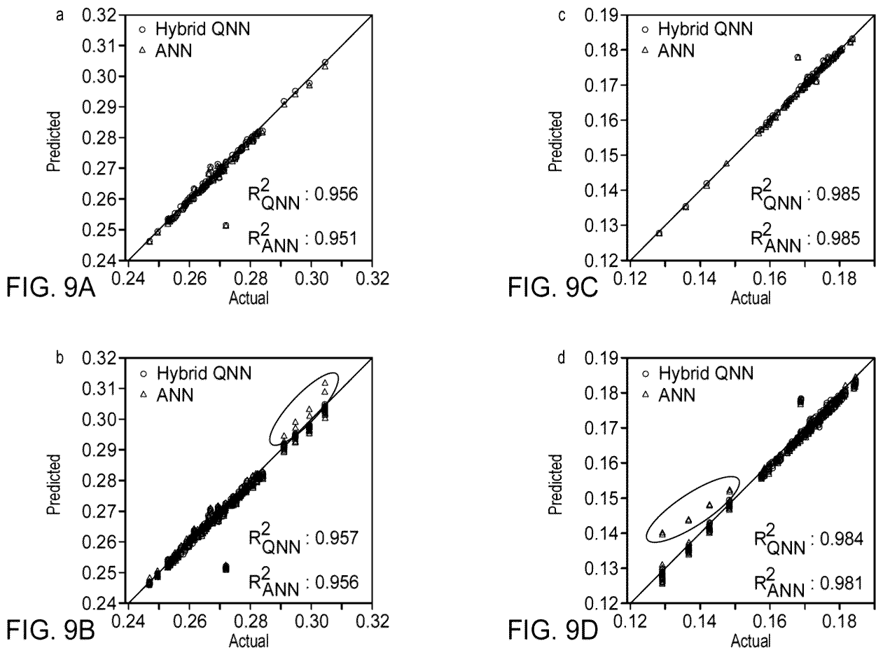

FIGS. 9A, 9B, 9C, and 9C illustrate parity plots of the products yield prediction of ANN and hybrid QNN models in single and multiple experiments. The X-axis represents actual ground truth (from data) values, while the Y-axis represents predicted values. Consequently, a higher concentration of data points aligning closely with the line, y is equal to x, indicates superior model performance.

FIGS. 9A and 9C present parity plots illustrating the prediction of EL and PL yields by the two proposed 69 models. FIG. 9A shows prediction of EL yield and FIG. 9C shows prediction of PL yield, each showing single model training. This graphical representation highlights the model performances of both the ANN and the hybrid QNN models in relation to the naphtha cracking product yields. Hybrid QNN demonstrates 0.956 and 0.985 R² for EL and PL yield prediction, respectively. In comparison, the ANN exhibits 0.951 and 0.985 R² for EL and PL yield prediction. This indicates a slightly higher R² for EL yield prediction with hybrid QNN, while maintaining a similar R² for PL yield prediction.

FIGS. 9B and 9D illustrate the parity plots of the 30 models which have different initial parameters, revealing distinct results. ANN models show more outliers in the predicted yields (encircled red), compared to QNN model. Hybrid QNN shows 0.957 and 0.984 R² for EL and PL yield prediction, respectively, while ANN shows 0.956 and 0.981 R² on average. Despite their comparable average R², the ANN models show some outliers in both EL and PL yield predictions indicated by the red circle. Consequently, it is proved that the hybrid QNN exhibits greater robustness to variations in initial parameters compared to the ANN.

In the embodiments described herein, a hybrid quantum neural network combining an artificial neural network and a quantum neural network is provided, to solve machine learning (ML) modeling problems. The hybrid quantum neural network has shown to have better prediction performance than a classical neural network, when trained with the same training sample, even with a small training sample size, at a faster training speed.

While the foregoing is directed to specific embodiments, other and further embodiments may be devised without departing from the basic scope thereof, and the scope thereof is determined by the claims that follow.

1. A method of performing computation in a hybrid quantum-classical computing system comprising a classical computer and a quantum processor, comprising:
executing one or more iterations, each iteration comprising:
receiving, by a classical computer, one or more input features of a training sample in a first classical neural network;
computing, by the classical computer, a plurality of first outputs from the first classical neural network based on a plurality of first trainable parameters;
setting, by a system controller, a quantum processor in an initial state, the quantum processor comprising a plurality of trapped ions, each of which has two hyperfine states defining a qubit;
applying, by the system controller, a parametrized quantum circuit to the quantum processor based on the plurality of first outputs and a set of variational parameters, the parametrized quantum circuit comprising:
one or more encoding layer circuits based on the plurality of first outputs, and one or more trainable layer circuits based on the set of variational parameters; and
measuring, by the system controller, qubit states of the quantum processor;
receiving, by the classical computer, measured expectation values of the qubit states of the quantum processor in a second classical neural network;
computing, by the classical computer, a plurality of second outputs from the second classical neural network based a plurality of second trainable parameters;
adjusting, by the classical computer, the plurality of first trainable parameters, the plurality of second trainable parameters, and the set of variational parameters; and
outputting, by the classical computer, the plurality of first trainable parameters, the plurality of second trainable parameters, and the set of variational parameters.

2. The method of claim 1, wherein the number of the plurality of first outputs is less than the number of the one or more input features of the training sample.

3. The method of claim 1, wherein
the first classical neural network comprises an input layer and an output layer that are fully connected to the input layer via the plurality of first trainable parameters; and
the second classical neural network comprises an input layer and an output layer that is fully connected to the input layer via the plurality of second trainable parameters.

4. The method of claim 1, wherein each of the one or more encoding layer circuit comprises single qubit rotation gates about y-axis individually applied to the plurality of qubits, encoding the plurality of first outputs in rotation angles of the single qubit rotation gates.

5. The method of claim 1, wherein each of the one or more trainable layer circuits comprises single qubit rotation gates about x, y, and z axes individually applied to the plurality of qubits and CNOT gates applied to pairs of the plurality of qubits.

6. The method of claim 1, wherein the parametrized quantum circuit comprises alternate applications of the one or more encoding layer circuits and the one or more trainable layer circuits.

7. The method of claim 1, wherein the adjusting is the plurality of first trainable parameters, the plurality of second trainable parameters, and the set of variational parameters is based on differences between the plurality of second outputs and one or more actual output features of the training sample that are associated with the one or more input features.

8. A hybrid quantum neural network (QNN) implemented in a hybrid quantum-classical computing system comprising a classical computer and a quantum processor comprising a plurality of qubits, the hybrid QNN comprising:
a first classical neural network implemented by a classical computer and configured to receive one or more input features of a training sample and compute first outputs based on a plurality of first trainable parameters;
a quantum neural network implemented by a quantum processor comprising a plurality of qubits, and configured to receive the first outputs from the first classical neural network and compute outputs, the quantum neural network comprising:
a preparation operation gate to set, by a system controller, the quantum processor in an initial state;
a parametrized quantum circuit comprising:
one or more encoding layer circuits, each comprising single qubit rotation gates individually applied, by the system controller, to the plurality of qubits to encode the outputs from the first classical neural network in rotation angles of the single qubit rotation gates;
one or more trainable layer circuits, each comprising single qubit rotation gates individually applied to the plurality of qubits and CNOT gates applied to pairs of the plurality of qubits; and
a measurement operation gate to measure, by the system controller, qubit states of the quantum processor; and
a second classical neural network implemented by the classical computer and configured to receive measured expectation values of the qubit states of the quantum processor and compute second outputs based on a plurality of second trainable parameters.

9. The hybrid quantum neural network of claim 8, wherein the number of the plurality of first outputs is less than the number of the one or more input features of the training sample.

10. The hybrid quantum neural network of claim 8, wherein
the first classical neural network comprises an input layer and an output layer that are fully connected to the input layer via the plurality of first trainable parameters; and
the second classical neural network comprises an input layer and an output layer that is fully connected to the input layer via the plurality of second trainable parameters.

11. The hybrid quantum neural network of claim 8, wherein each of the one or more encoding layer circuits comprises single qubit rotation gates about y-axis individually applied to the plurality of qubits, encoding the plurality of first outputs in rotation angles of the single qubit rotation gates.

12. The hybrid quantum neural network of claim 8, wherein each of the one or more trainable layer circuits comprises single qubit rotation gates about x, y, and z axes individually applied to the plurality of qubits and CNOT gates applied to pairs of the plurality of qubits.

13. The hybrid quantum neural network of claim 8, wherein the parametrized quantum circuit comprises alternate applications of the one or more encoding layer circuits and the one or more trainable layer circuits.

14. A hybrid quantum-classical computing system, comprising:
a quantum processor comprising a plurality of trapped ions, each of the trapped ions having two hyperfine states defining a qubit;
one or more lasers configured to emit a laser beam controlled by a system controller, which is provided to trapped ions in the quantum processor; and
a classical computer configured to:
execute one or more iterations, each iteration comprising:
receiving one or more input features of a training sample in a first classical neural network;
computing a plurality of first outputs from the first classical neural network based on a plurality of first trainable parameters;
controlling the system controller to set a quantum processor in an initial state;
controlling the system controller to apply a parametrized quantum circuit to the quantum processor based on the plurality of first outputs and a set of variational parameters, the parametrized quantum circuit comprising:
one or more encoding layer circuits based on the plurality of first outputs, and one or more trainable layer circuits based on the set of variational parameters; and
measuring, by the system controller, qubit states of the quantum processor;
receiving measured expectation values of the qubit states of the quantum processor in a second classical neural network;
computing a plurality of second outputs from the second classical neural network based a plurality of second trainable parameters;
adjusting the plurality of first trainable parameters, the plurality of second trainable parameters, and the set of variational parameters; and
output the plurality of first trainable parameters, the plurality of second trainable parameters, and the set of variational parameters.

15. The hybrid quantum-classical computing system of claim 14, wherein each of the trapped ions is ¹⁷¹Yb⁺ having ²S_{1/2} hyperfine states.

16. The hybrid quantum-classical computing system of claim 14, wherein the number of the plurality of first outputs is less than the number of the one or more input features of the training sample.

17. The hybrid quantum-classical computing system of claim 14, wherein
the first classical neural network comprises an input layer and an output layer that are fully connected to the input layer via the plurality of first trainable parameters; and
the second classical neural network comprises an input layer and an output layer that is fully connected to the input layer via the plurality of second trainable parameters.

18. The hybrid quantum-classical computing system of claim 14, wherein each of the one or more encoding layer circuits comprises single qubit rotation gates about y-axis individually applied to the plurality of qubits, encoding the plurality of first outputs in rotation angles of the single qubit rotation gates.

19. The hybrid quantum-classical computing system of claim 14, wherein each of the one or more trainable layer circuits comprises single qubit rotation gates about x, y, and z axes individually applied to the plurality of qubits and CNOT gates applied to pairs of the plurality of qubits.

20. The hybrid quantum-classical computing system of claim 14, wherein the parametrized quantum circuit comprises alternate applications of the one or more encoding layer circuits and the one or more trainable layer circuits.
